(19) United States
(12) Patent Application Publication
(10) Pub. No.: US 2021/0361981 A1
(43) Pub. Date: Nov. 25, 2021

(54) Chute and Method

(71) Applicant: Ghassan Nehaili, Glasgow (GB)

(72) Inventor: Ghassan Nehaili, Glasgow (GB)

(21) Appl. No.: 16/968,113

(22) PCT Filed: Feb. 4, 2019
(86) PCT No.: PCT/GB2019/050292

§ 371 Date: Aug. 6, 2020

(30) Foreign Application Priority Data
Feb. 7, 2018 (GB) 1801999.2

(51) Int. Cl. A62B 1/20; A63G 21/02

(52) U.S. Cl. CPC A62B 1/20; A63G 21/02

(57) ABSTRACT

The invention relates to a chute (10) for safely transporting a person from a height, for example from a highrise building (33—see FIG. 3). The chute comprises a flexible cylindrical inner tube (20) for accommodating a person (36); a plurality of circumferential sleeves (21) arranged axially along the inner tube (20); and a plurality of elastically deformable bands (27) accommodated in the sleeves (21). The sleeves (21) are distributed such that a plurality of the bands (27) are configured to extend circumferentially around a person (36) within the inner tube (20) during use, to thereby allow safe descent from a height.

The present invention relates to a chute and method, particularly, but not exclusively, a chute and method for enabling a person to safely descend from a height.

In recent years several tragedies reported widely in the media have highlighted the need for a method and device to allow people to safely exit upper floors of high rise buildings in an emergency. A variety of escape devices have been designed but are not widely adopted due to drawbacks such as cost, weight and risk of harm to users. In addition, conventional solutions require user input in order to descend safely. There remains a need for a method and device that enables safe exit from high rise buildings that is reliable, lightweight, cost effective and suitable for use by people of all ages and abilities.

According to a first aspect of the present invention, there is provided a chute for safely transporting a person from a height, the chute comprising:
a substantially flexible cylindrical tube configured to accommodate a person,
a plurality of circumferential sleeves arranged axially along the tube,
a plurality of bands of elastically deformable material, wherein the bands of elastically deformable material are accommodated in the sleeves; and
wherein the sleeves are spaced such that a plurality of bands are configured to extend circumferentially around a person within the tube in use to thereby allow safe descent from a height.

Thus, the chute has a number of bands in close proximity such that a person within the chute is surrounded by several bands of elastically deformable material to absorb the energy of a descent and thereby safely transport a person from a height.

Optionally, the chute is configured for use in a substantially vertical or near vertical position.

The cylindrical tube may comprise a soft flexible material. The cylindrical tube may comprise a fabric material. The cylindrical tube may comprise a strong fabric material. Optionally, the cylindrical tube is made from a high strength low weight material.

Optionally, the cylindrical tube is made from a material having low friction. Alternatively or additionally, the cylindrical tube may be coated with a material having low friction.

Optionally, the cylindrical tube is made from nylon fabric. Alternatively, the cylindrical tube is made from another light strong suitable fabric. Optionally, the cylindrical tube is coated with silicon. The cylindrical tube may be made from silicon coated nylon fabric.

Optionally, the chute is adapted to be expandable to allow a person to pass therethrough. The chute may be adapted to be expandable. The chute may be expandable between a first diameter and a second larger diameter.

The first diameter of the chute may correspond to the diameter of the bands. The first diameter of the chute may be less than the normal width of a person. The first diameter may be between 10 cm and 40 cm.

The second larger diameter of the chute may correspond to a greater diameter of the as-manufactured dimensions of the tube. The circumference of the chute may be between around 100 cm and 220 cm. The circumference of the chute may be around 210 cm. The circumference of the chute may be greater than 200 cm.

Optionally, the material of the cylindrical tube is gathered or ruched around the bands to allow expansion between the first diameter and the second diameter.

Alternatively, the cylindrical tube may be designed with a series of openings that allow expansion of the flexible tube.

Optionally, the substantially cylindrical flexible tube comprises an inner tube and an outer tube attached to the inner tube. The substantially cylindrical flexible tube may comprise an inner tube and an outer tube concentrically arranged outwith the inner tube.

The outer tube may comprise a tough flexible material. The cylindrical outer tube may comprise a strong fabric material. The outer tube may be made from a high strength low weight material. The outer tube may be made from a flame resistant material. The outer tube may be made from a heat resistant material. The outer tube may be inflammable.

At least a portion of the outer tube may be made from a material selected from the group consisting of: nylon fabric, Kevlar and Nomex.

Each sleeve may be formed from a portion of the cylindrical flexible tube. Alternatively, the sleeve can be formed from a separate strip of material.

Optionally, each sleeve may be sewn into the cylindrical flexible tube.

Each sleeve may be formed from a portion of the inner cylindrical flexible tube and a portion of the outer cylindrical flexible tube.

The inner and outer tubes may be concentrically joined at regular intervals with a sleeve being created between adjacent joins. The inner and outer tubes may be joined by sewing.

The inner and outer tubes may be concentrically sewn at axial intervals to make circumferential sleeves between consecutive lines of stitching.

Optionally, the sleeves are regularly spaced along the chute. Alternatively, the sleeves may be irregularly spaced along the chute.

The sleeves may be continuously disposed along the length of the chute. The sleeves may be disposed along the full length of the chute. Alternatively, there may be one or more portions of the chute containing no sleeves and bands.

The total number of sleeves accommodating bands may be selected according to the application and desired weight limits of the chute. The total number of sleeves accommodating bands can vary according to the application and desired rate of travel through the chute.

Optionally, bands of elastically deformable material may be located only within selected sleeves of the chute. Thus, standard chutes can be manufactured and the number of elastic restraints in the form of deformable bands can be selected according to the application.

Alternatively, an elastically deformable band may be located within each sleeve of the chute.

The width of each sleeve may be between 1 cm and 12 cm. The width of each sleeve may be between 2 cm and 10 cm. The width of each sleeve may be between 3 cm and 8 cm. The width of the sleeves may be around 10 cm.

The spacing between adjacent bands may be around 1 cm and 12 cm. The spacing between adjacent bands may be between 2 cm and 10 cm. The spacing between adjacent bands may be between 3 cm and 8 cm. The spacing between adjacent bands may be around 10 cm.

Therefore, a person may be surrounded by at least ten circumferential bands in use. A person of average height may be surrounded by at least fifteen bands in use.

The bands may form a continuous circumferential loop. Each band may be formed from a strip of material that is joined at its free ends. Each band may be formed from a moulded circumferential loop. Each band may be formed from a strip of material that is joined at the free ends, wherein the ends are joined without puncturing the material of the band.

Preferably, the bands are joined by at least one joining member. The joining member may join the free ends of the bands to form a loop with a predetermined circumference. Each band may be provided with at least one predetermined mark at which the joining member is affixed. The joining member may retain the ends of the bands and maintain a consistent loop circumference by friction.

The joining member may comprise at least one ring. The joining member may comprise two rings and the free ends of the band may be threaded between the rings. The rings may have a diameter of between around 25 mm and 30 mm. The rings may be made from aluminium, plastic or another suitable lightweight durable material.

The bands may be secured by a securing member. Free ends of the bands may be secured by a securing member. The securing member may be used alongside the joining member. The securing member may comprise a cable tie or at least one knot.

Alternatively, the free ends of each band may be tied. The free ends of each band may be joined by knotting. The free ends of each band may be joined by two simple knots. The knots may be tensioned to a desired degree. The knots can be tensioned to a measurable predetermined figure to ensure quality control and ensure the chute can be tested to conform with safety requirements.

Alternatively, or additionally, the bands may be joined using an adhesive. Alternatively, or additionally, the bands may be joined by heat bonding.

The chute may further comprise a securing member. The join between the ends of the bands may be secured with a securing member. The join between the ends of the bands may be secured with a securing member to substantially protect the join between the ends of the bands. The securing member may be a shrink wrap. The securing member may be a cable tie. The securing member may be an adhesive.

Optionally the joined ends of the bands are covered. Preferably, the joined ends of the bands are covered such that they are inaccessible in use. Longitudinal edges of the outer tube may be connected to cover the bands of the chute. The outer tube may be longitudinally sewn along its length to cover the bands of the chute and restrict access thereto. It is advantageous to cover the bands to protect them during deployment of the chute and to restrict snagging and/or damage thereto.

Optionally, each band moves unhindered within the sleeve. Therefore each band may rotate within the sleeve in response to external forces. Thus, each band may be free to move within the sleeve to minimise strain on any part of the band or joining member.

The length and resultant diameter of the bands may be preselected according to the particular application and desired rate of descent through the chute.

The length and resultant diameter of the bands may be reduced to ensure a slower descent through the chute. Thus, the chute may be provided with braking zones to slow the speed and control the descent of a user. A braking zone of the chute having reduced diameter bands may be located towards a lower end of the chute.

The length and resultant diameter of the bands may be increased to increase the speed of descent of a user.

The diameter of the circumferential bands may be between 10 and 40 centimetres. The diameter of the circumferential bands may be between 12 and 35 centimetres. The diameter of the circumferential bands may be between 15 and 30 centimetres. The diameter of the circumferential bands may be around 11 to 25 centimetres.

The chute can be divided into portions and each portion may include a repeating pattern of gradually narrowing bands. The repeating portions can be around between 1 m and 2 m in length. The repeating portions can be around between 1.2 m and 1.6 m in length. The repeating portion can be around 1.4 m in length. The diameter of the bands in each portion can vary from around 25 cm to 11 cm. At least two bands of each similar diameter may be provided.

The width of the circumferential bands may be between 1 cm and 7 cm. The width of the circumferential bands may be between 2 cm and 5 cm. The width of the circumferential bands may be between 3 cm and 4 cm. The width of the circumferential bands may be around 3.5 cm.

The bands provide the chute with a first restricted diameter and the chute may be expandable to a second as-manufactured diameter of the tube, due to the inherent elasticity of the bands. As a result of the sleeving of smaller diameter bands within a wider diameter sleeve, the material of the inner and outer tubes adjacent the circumferential bands may be gathered or ruched.

The thickness of the circumferential bands may be between 0.4 mm and 1.4 mm. The thickness of the circumferential bands may be between 0.6 mm and 1.2 mm. The thickness of the circumferential bands may be between 0.8 mm and 1.0 mm. The thickness of the circumferential bands may be around 0.9 mm.

The bands may be made from a resilient material such that they elastically deform on contact with a force. The bands may be made from a resilient material such that they absorb energy by hysteresis. The bands may be made from a material selected from the group consisting of: rubber, natural rubber and silicon rubber.

The chute may further comprise a reinforcing means to increase the strength of the chute.

The chute may further comprise a load distributer to substantially distribute the load along the length of the chute.

The reinforcing means and/or the load distributer may be located on the outer tube.

The reinforcing means and/or the load distributer may extend axially along an exterior of the outer tube. The reinforcing means and/or the load distributer may extend within a portion of the interior of the outer tube towards its upper end. The reinforcing means and/or the load distributer may extend radially around the outer tube.

The reinforcing means and/or the load distributer may comprise at least one longitudinal webbing strap extending along the chute. The reinforcing means and/or the load distributer may comprise four longitudinal webbing straps extending along the length of the chute. The four longitudinal webbing straps may be located at 90° intervals along the length of the chute. The reinforcing means and/or the load distributer may include at least one webbing strap extending radially around the chute. The at least one radial webbing strap may be fixed to the at least one longitudinal webbing strap.

The webbing straps may be joined to the chute by sewing.

Each webbing strap may have a breaking point over 500 kg. Each webbing strap may have a breaking point of around 700 kg.

The webbing straps may be between 15 mm and 30 mm wide. The webbing straps may be between 20 mm and 25 mm wide. The webbing straps may be around 22 mm wide.

The webbing straps may be between 0.5 mm and 2 mm thick. The webbing straps may be around 1 mm thick.

Additional webbing straps may be provided towards an upper end of the chute. Additional webbing straps may be located on the interior and/or exterior of the chute.

The webbing straps may be made from closely woven fabric resulting in a strap having high strength. The webbing straps may be made from any material selected from the group consisting of: yarn, flame retardant nylon, polypropylene, kevlar and Nomex.

The combination of axial and radial webbing straps allows a distribution of the forces acting on the chute and improves strength of the chute.

The total weight and dimensions of the chute may be selected such that the chute is transportable by hand. The weight of the chute may be between 200 g and 1500 grams per metre. The weight of the chute may be between 300 g and 1200 grams per metre. The weight of the chute may be between 400 g and 1000 grams per metre. The weight of the chute may be between 500 g and 800 grams per metre. The weight of the chute may be around 600 grams per metre.

The chute may further comprise a plurality of apertures. The apertures may extend through a sidewall of the cylindrical flexible tube. The apertures can allow air circulation within the chute. The apertures may extend through the sidewall of the inner and outer tube.

The apertures may be less than about 1 centimetre diameter. The apertures may be around 2 mm in diameter. The apertures may be arranged in a circular configuration in groups of six.

At least two circular configurations of apertures may be located at 1 metre intervals along the length of the chute.

The apertures may be made using a heated rod. An outline of each aperture may comprise an eyelet to substantially restrict tearing of the cylindrical tube.

Four circular configurations of apertures may be provided radially equispaced at 90° intervals every 1 metre along the chute. The apertures may be located between the reinforcing means and/or load distributer.

The chute may be collapsible to fit within a carry case. The chute may comprise a carry case for enclosing the chute. The carry case may be formed from a rigid material. The carry case may be made from aluminium.

The chute may further comprise a frame for supporting the chute at an upper end alongside another structure. The structure can include any building, office block, flats, tenement, factory, helicopter, crane, platform, rig, or any other tall structure.

The frame may comprise at least two hook portions for supporting the frame against a structure in use. The hook portions may be foldable to reduce the stowed dimensions of the frame.

At least one of the chute and the frame may be provided with anchor means for anchoring the chute to the frame. The frame may be made from aluminium. The frame may weigh less than around 6 kg.

The reinforcement means and/or load distributor may form part of the anchor means to anchor the chute to the frame. The reinforcement means and/or load distributer may distribute the load of the chute carried by the frame.

The chute may further comprise at least one container for carrying a load within the chute.

The at least one container may be shaped such that it travels effectively within the chute. The at least one container may be shaped such that it fits within the carry case.

The at least one container may be appropriately weighted to ensure effective travel within the chute. The at least one container may be weighted at its leading end. The at least one container may be weighted with a heavy substance such as concrete or metal.

The at least one container may comprise a safety harness to secure the load within. The at least one container may contain breathing holes. The container may be used to transport pets, babies, objects, possessions, debris and the like depending on the particular application.

The chute may create a distinctive sound during descent of a person therethrough. The chute may create a distinctive calming sound during descent of a person therethrough to calm the person on descent and reduce fear. The chute may create a distinctive rustling sound during descent of a person therethrough. The rustling sound can be comparable to the sound of walking through autumn leaves. Enhanced audible effects, such as rustling or other noises may be created by selecting different types and characteristics of fabric comprising the chute.

The sound effects may be created by the materials comprising the chute, the structure of the chute and/or the arrangement of the circumferential bands.

The chute may create at least two distinctive sounds during descent of a person therethrough. The chute may create a distinctive sound corresponding to the position of a person therein. Example sounds include rustling, crackling, ringing bells and the like. Additional accessories may be fixable to the chute to generate different sound effects.

The chute may be an emergency evacuation chute.

The chute may be recreation equipment such as a fun slide.

The chute may be a therapeutic device for providing a physical sensation to enhance wellbeing.

According to a second aspect of the invention, there is provided a method of enabling a person to descend safely from a height, the method comprising the steps of:
providing a substantially flexible cylindrical tube comprising a plurality of bands of elastically deformable material accommodated within a plurality of circumferential sleeves axially arranged along the tube and spacing the bands such that several bands extend circumferentially around a person within the chute in use,
allowing a person to enter an upper open end of the tube,
allowing descent of the person by gravity, and
controlling the speed of descent by absorbing a portion of the energy of the descent by elastically deforming the plurality of bands.

Thus, the bands absorb the energy from a person's descent. This is advantageous since the user is passive and is not required to be actively involved in the descent using the chute. The person within the chute will descend under their own weight at a controlled speed due to the absorption of energy by the bands. As a result, the chute is suitable for use by people of diverse abilities, meaning that all people have the same opportunity to escape in emergency situations.

According to a third aspect of the invention, there is provided a kit of parts for an evacuation chute, the kit of parts comprising the chute of the first aspect of the invention and a frame adapted to anchor the chute, wherein the frame is securable to a structure to allow vertical or near vertical deployment of the chute.

The kit of parts may further comprise a carry case for stowing the chute and the frame.

According to a fourth aspect of the present invention, there is provided a method of manufacture of a chute, the method including the steps of:
forming a substantially flexible cylindrical tube,
creating a plurality of circumferential sleeves arranged at intervals along the tube,
inserting bands of an elastic material into the sleeves, and
securing free ends of each band around at least one joining member to form a loop with a predetermined circumference.

The method may include marking the bands to indicate the position at which the joining member is attached. Each band may be provided with at least one predetermined mark at which the joining member is affixed. The joining member may retain the ends of the bands and maintain the predetermined loop circumference by friction.

The method may include securing the free ends of the bands using at least one ring. The joining member may comprise at least one ring. The joining member may comprise two rings and the free ends of the band may be threaded between the rings. The rings may have a diameter of between around 25 mm and 30 mm. The rings may be made from aluminium, plastic or another suitable lightweight and durable material.

The bands may be further secured by a securing member. Free ends of the bands may be secured by a securing member. The securing member may be used alongside the joining member. The securing member may comprise a cable tie or at least one knot.

According to a fifth aspect of the invention, there is provided a method of treatment by therapy comprising:
providing a substantially flexible cylindrical tube and a plurality of bands of elastically deformable material accommodated within a plurality of axially arranged circumferential sleeves,
enabling a person with non-typical neurological symptoms to descend within the tube by gravity,
controlling the speed of descent by absorbing a portion of the energy of the descent by elastically deforming the plurality of bands, and
thereby increasing the wellbeing of the person descending.

The chute is a tight enclosed space and a user experiences a hugging and pressing sensation on descent. The descent experience is simultaneously calming, due to the rustling sounds and enclosed nature of the chute, and exhilarating due to the descent sequence. This combination of sensations stimulates the release of chemicals such as serotonin and adrenaline, which contribute to an overall sense of wellbeing. This is useful in treating by therapy those having non-typical neurological symptoms such as individuals having an autism spectrum disorder (ASD).

The method may include creating a calming sound on descent. The calming sound can be created as a result of the material of the chute and the noise of a person descending within. The calming noise may be similar to the rustling of autumn leaves.

The method of therapy may include creating at least two distinct noises on descent. The at least two noises can be linked to the location of the user within the chute. The noises can be created by adding accessories to the chute to recreate the noise of bells, water, rustling, animal sounds and the like.

Any feature of any aspect or embodiment of the invention can be interchangeable with, and applicable to, any other aspect of the invention where appropriate. Further features and advantages of the first, second, third, fourth and fifth aspects of the present invention will become apparent from the claims and the following description.

Embodiments of the present invention will now be described by way of example only, with reference to the following diagrams, in which:

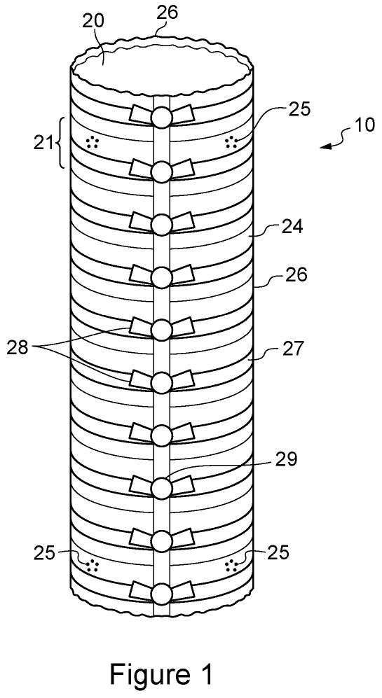

FIG. 1 is a perspective view of a portion of a chute according to a first embodiment of the invention;

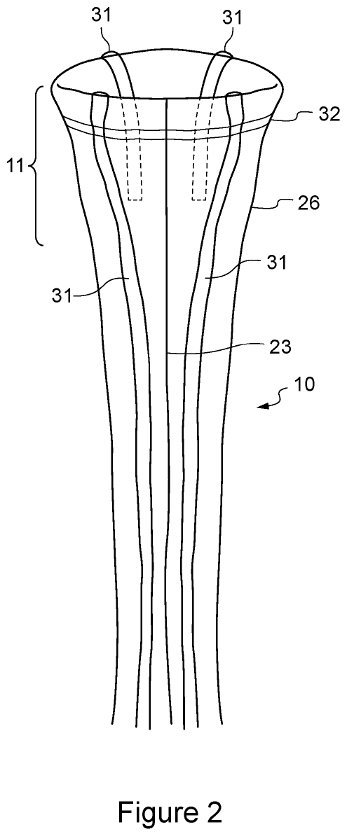

FIG. 2 is a perspective view of an exterior of the chute of FIG. 1;

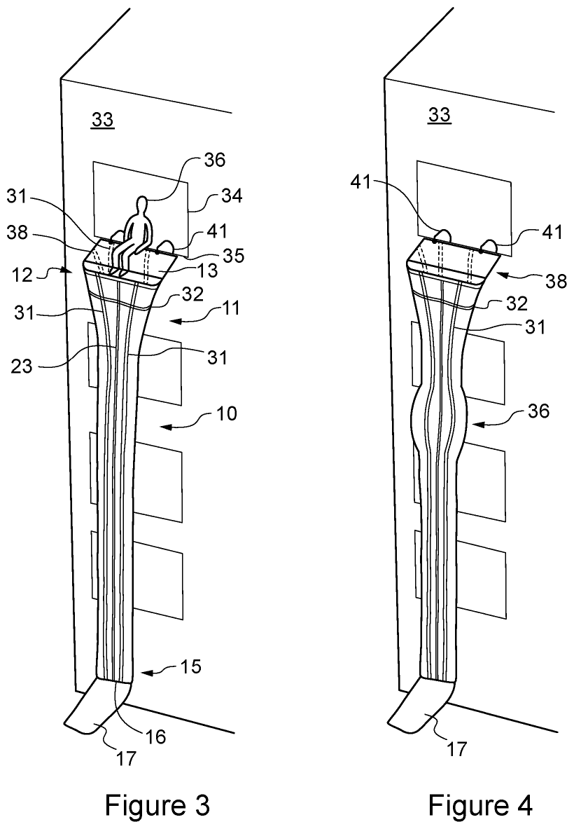

FIGS. 3 and 4 are perspective views of the chute of FIGS. 1 and 2 and a frame in a deployed configuration in use to facilitate exit from a building;

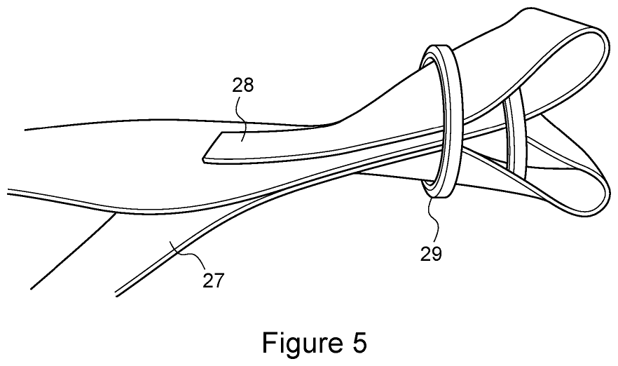

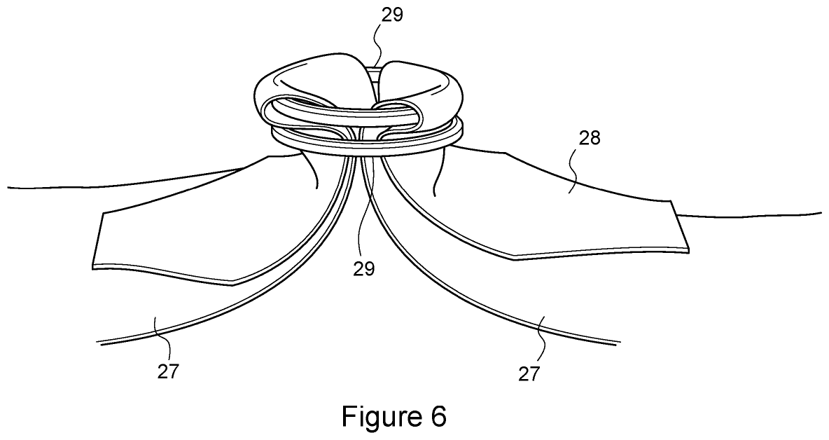

FIGS. 5 and 6 are perspective views of a joining member joining free ends of a band within the chute;

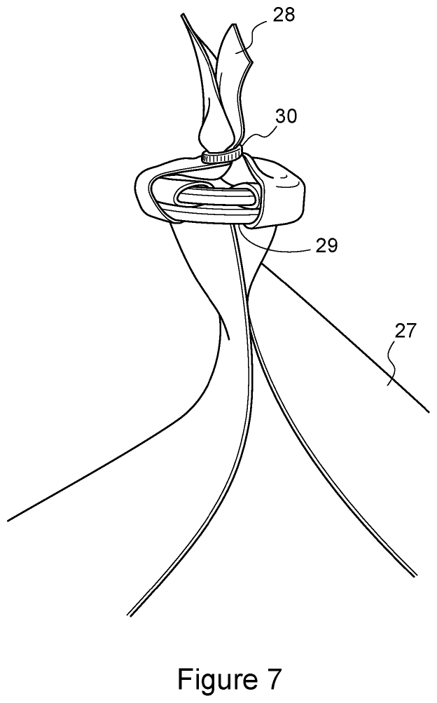

FIG. 7 is a perspective view of a securing member and the joining member of FIGS. 5 and 6, securing the free ends of the band;

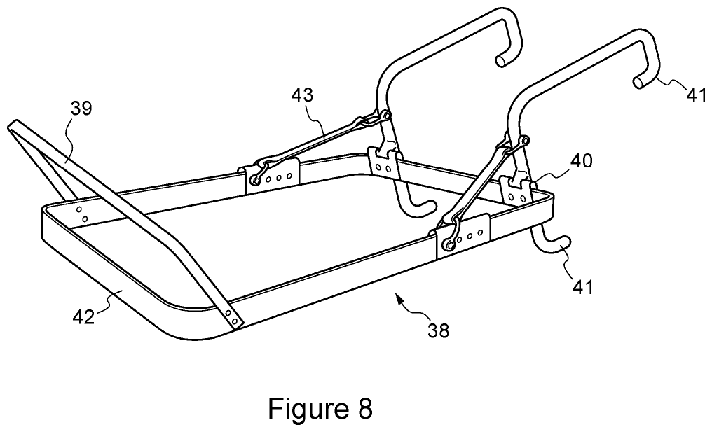

FIG. 8 is a perspective view of the frame of FIGS. 3 and 4 used in conjunction with the chute;

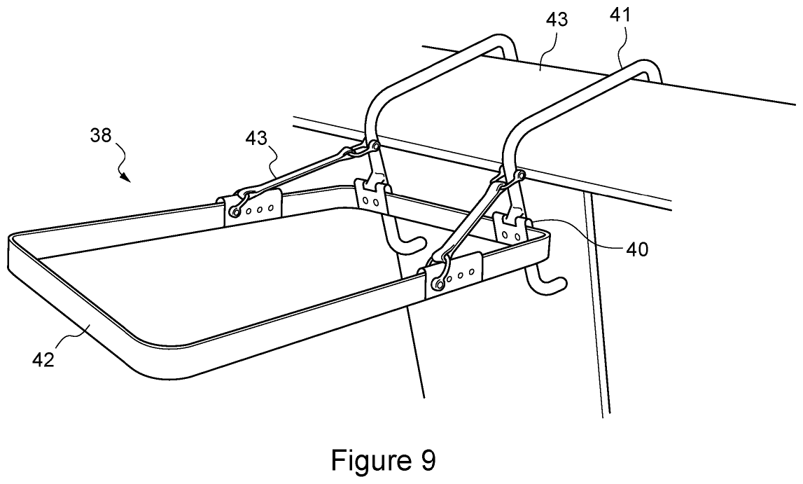

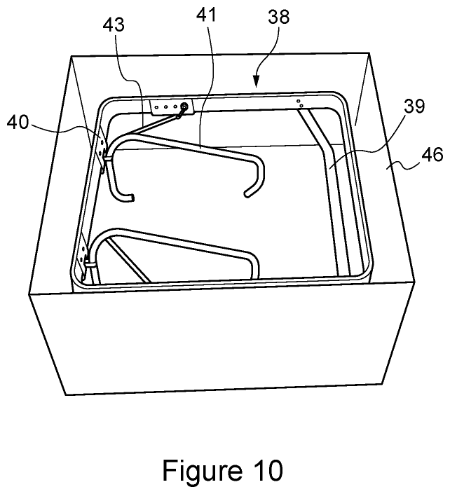

FIG. 9 is a perspective view of the frame of FIG. 8 deployed and supported by a structure;

FIG. 10 is a perspective view of the frame of FIG. 8 within a case;

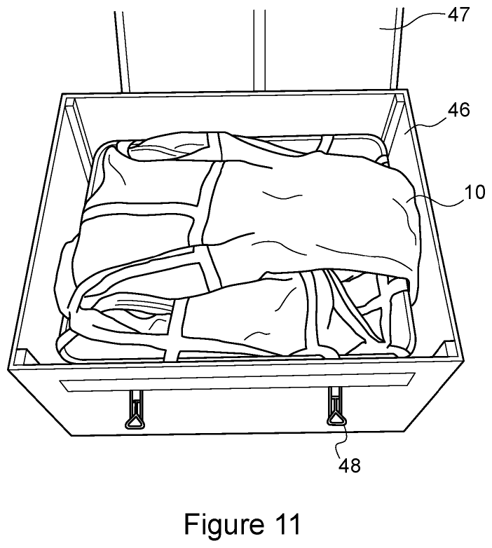

FIG. 11 is a perspective view of the frame and the chute of FIG. 2 packed within the case;

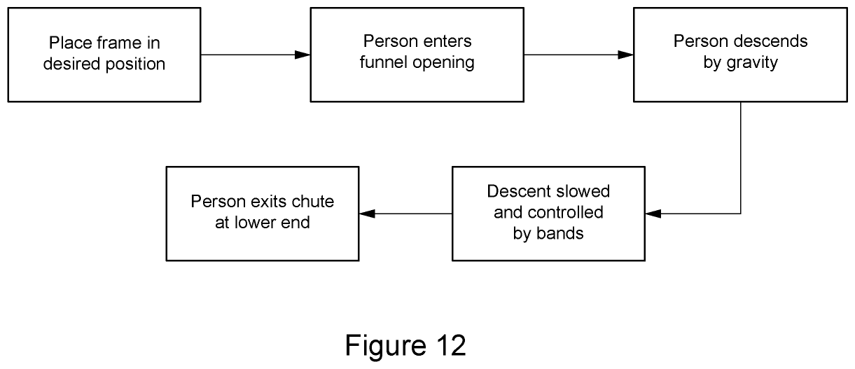

FIG. 12 is a flow diagram of the method of the invention; and

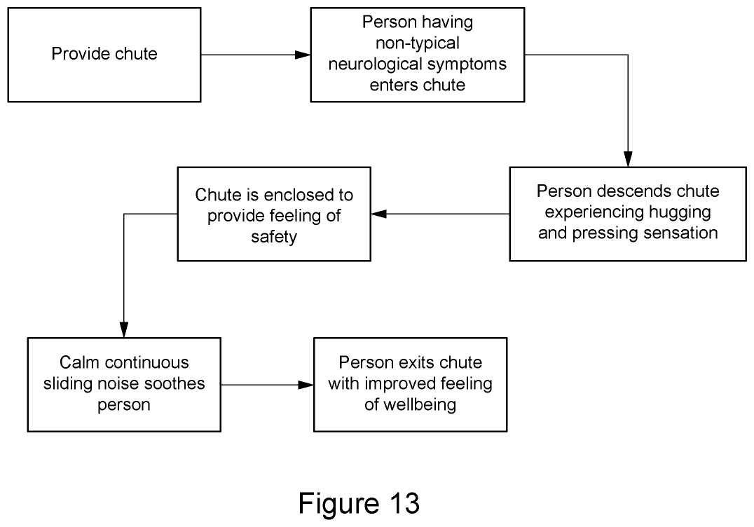

FIG. 13 is a flow diagram of another embodiment of the invention.

A chute according to the first aspect of the present invention is shown generally at 10 in FIG. 1. The chute 10 comprises an inner tube 20 concentrically arranged within an outer tube 26. The inner tube 20 is made from silicon coated nylon fabric. This material is strong and light. The silicon coating reduces friction in use. The outer tube 26 is made from flame retardant material, such as Kevlar, Nomex, or flame retardant polyester.

As shown in FIG. 2, an exterior of the outer tube 26 has four lengths of webbing straps 31 longitudinally sewn along the chute and located at 90° intervals. The webbing straps 31 extend axially along the exterior of the length of the outer tube 26 and loop over a funnel 11 at an upper end 12 of the outer tube 26. The webbing straps 31 are sewn within the interior of the upper end 12 of the tube 26 to the end of the funnel 11. A radial webbing strap 32 linking the four longitudinal webbing straps 31 is sewn on the exterior of the outer tube 26 a few centimetres below the top of the funnel 11. Additional webbing straps 31 can be sewn over the funnel 11 to distribute load and reinforce the chute 10.

The inner and outer tubes 20, 26 are made by joining long edges of rectangular lengths of the respective fabric into a tubular shape. The length of the inner and outer tubes 20, 26 is identical, although the fabric making up the outer tube 26 has a slightly greater width. The extra fabric of the outer tube 26 is used to cover rings 29 used to create the bands 27. The fabric is sewed along a longitudinal seam 23 to create tubes 20, 26 having a diameter of at least 210 cm. The 210 cm diameter is an as-manufactured diameter of the tubes 20, 26 prior to insertion of any bands 27. Creating inner and outer tubes 20, 26 with such a wide diameter allows the chute 10 to accommodate the wide range of human sizes.

Radial strips of the inner and outer tubes 20, 26 are concentrically sewn together approximately every 10 cm to create circumferential sleeves 21. The resultant sleeves 21 are created between adjacent lines of stitching. The sleeves 21 are approximately 10 cm wide and are continuously provided along the full length of the chute 10. Each sleeve 21 has adjacent openings 22 in the region of the seam 23 through which strips of long-life silicon rubber are fed. The strips of rubber are 0.8 mm thick and 35 mm wide. The strips of rubber are marked to provide a visual indicator of the position at which their free ends 28 need to be joined to create the desired circumference. Free ends 28 of the rubber strips are joined by a joining member in the form of two aluminium rings 29 to create circumferential bands 27 (FIG. 5). The free ends 28 of the strips are looped through the rings 29 and pulled taut to restrict slippage (FIG. 6). The rings 29 are secured using a securing member in the form of a cable tie 30 (FIG. 7). Connecting the free ends 28 of the strips with rings 29 ensures that the creation of the bands 27 does not damage or puncture the rubber strips.

Once the bands 27 have been formed by joining the free ends 28 of the rubber strips with rings 29, a seam 23 connecting the longitudinal edges of the outer tube 26 is sewn over the rings 29 such that the rings 29 and bands 27 are neither visible nor accessible in the finished chute 10 as shown in FIG. 2.

FIG. 1 shows the bands 27 centred within the sleeves 21. During use in a vertical position it is likely that the bands 27 will settle at the bottom of each sleeve 21 due to gravity.

The bands 27 create a longitudinal pattern of waist loops. The bands 27 are arranged in a pattern along the chute. The pattern repeats in sections around every 1.4 metres. Each section has bands 27 with a wider diameter gradually reducing in size to bands 27 having a smaller diameter. For example, at the top of each section, there are two bands 27 having a 61 cm circumference resulting in a diameter of around 19 cm. The next two bands 27 have a circumference of around 58 cm giving a diameter of approximately 18 cm. The next two bands 27 have a 55 cm circumference, giving an approximate diameter of 17 cm. Another two bands 27 have a 52 cm circumference resulting in approximately 16 cm diameter. The following three or four bands 27 have a 49 cm circumference and approximately 15 cm diameter. The following two bands 27 have a 46 cm circumference and a 14 cm diameter and so on. Thus, a 1.4 m section of chute 10 is created with gradually reducing band 27 diameters. This pattern repeats again with the next section of chute 10. Therefore, at the top of the next section of chute 10 the uppermost band will have a 61 cm circumference and a diameter of 19 cm.

The bands 27 accommodate people of all sizes. For example, a child having a small diameter and a large adult having a greater diameter can both be safely transported with similar controlled descent speed using the inherent elongation of the silicon rubber bands 27. The degree of ‘stretch’ permitted by the bands is around 500%. The hysteresis effect means the rubber absorbs a proportion of the energy of the descending person.

Since the rubber bands 27 are joined such that the diameter of the chute 10 is between around 13 cm and 19 cm, the bands 27 reduce the circumference of the chute 10 from 210 cm to a diameter of between around 13 and 20 cm. The smaller diameter bands 27 within wider sleeves 21 result in excess material of the inner and outer tubes 20, 26. The excess material is pulled together to create a gathered or ruched area 24 of fabric. This area of gathered fabric 24 occurs due to the sleeving of smaller rubber bands 27 within the larger diameter tubes 20, 26 and creates an air cushioning effect as a person descends the chute 10. This also decreases the friction experienced by a user.

Apertures in the form of air holes 25 are created through the sidewall of the tubes 20, 26 using a heated rod. A round pattern of holes 25 is created at equispaced locations along the radius of the chute 10 at approximately 1 metre intervals. These holes 25 allow air to be drawn into the chute 10 as a user descends.

As shown in FIG. 3, the funnel 11 of the chute 10 is located at its upper end 12. The funnel portion 11 is approximately 50 cm in length and has an upper opening 13 through which a person enters the chute 10. The funnel 11 is a hollow frustoconical shape to enable a person to safely enter the chute 10 via a wider opening 13. The funnel 11 has no bands 27. These design features at the upper end 12 of the chute 10 enable entry and initiation of a user's descent through the chute 10.

The main body of the chute 10 comprises the sections having the repeated pattern of bands 27 such that the freefall speed is reduced in use between 8 to 20 times.

Towards a lower end 15 of the chute 10, the diameter of the bands 27 is reduced to provide a braking zone. The portion of bands 27 with a smaller diameter in the braking zone increases resistance to the descending user and therefore slows their descent at a critical point above the ground.

At the lower end 15 of the chute 10, a soft landing pad 17 can be provided below a lower opening 16, through which a user exits the chute 10. The landing pad 17 can be useful for people who are injured, unconscious or otherwise immobile and have reached the end of the chute 10, their descent having been controlled by the rubber bands 27.

Alternatively, the length of the chute 10 is selected such that the opening 16 at the lower end 15 is around at least one metre from the ground. This allows a user to exit the chute 10 in an upright position and walk away from the chute 10 to clear the area around the lower opening 16 as quickly and efficiently as possible.

FIG. 8 shows an aluminium frame 38 comprising a rectangular support 42. Two hooks 41 are pivotally attached 40 along one edge of the rectangular support 42. The hooks 41 also act as handles to assist a person climbing upon the frame 38 and optimally positioning themselves to enter the opening 13 of the chute 10. A securing strap 43 extends between a mid-portion of the rectangular support 42 and a mid-part of the hooks 41 to further secure and support the frame 38. The securing straps 43 additionally lift the rectangular support 42 in use, such that the rectangular support 42 is angled towards the hooks 41 rather than horizontally aligned. Use of the securing straps 43 to tilt the rectangular support 42 towards an opening or exit in use is advantageous because the frame 38 thereby creates a partial frontal screen to alleviate fear for those suffering from a fear of heights. A bar 39 is fixed on the rectangular support 42 and the bar 39 provides an additional handling point for the frame 38. The upper end 12 of the chute 10 is anchored to the rectangular support 42 in use. The frame weighs between around 5 kg to 6 kg and can therefore be lifted into position with the hooks 41 over a supporting structure. FIG. 9 shows the frame in use over a structure.

The frame 38 provides one example of a means for supporting the chute 10 alongside a rigid structure such as a building. Alternative frame 38 designs and arrangements can also be used in combination with the chute 10.

The chute 10 is collapsible because the flexible fabric is foldable and there is no rigid frame along the length of the chute 10. The chute 10 is placed in a rigid case 46 with the frame 38 laid atop as shown in FIG. 11. The case 46 is a cuboid and around the size of a large suitcase. The case 46 has a lid 47 and clasps 48 for securing the lid 47 in position. FIG. 10 illustrates how the frame 38 folds for storage within the case 46. The hooks 41 pivot 40 around the rectangular support 42, such that the hooks 41 fold inwardly to reduce the overall dimensions of the frame 38. The total weight is such that the case containing the chute 10 is transportable by an adult. The carry case for the chute 10 can be provided with casters to further facilitate transport of the packaged chute 10. The weight of the chute 10 is around 600 grams per metre.

An example of the method of use is now described with reference to FIGS. 3, 4 and 12. According to the present embodiment, a building 33 shown in FIGS. 3 and 4 is consumed by fire and smoke. People on the upper floor have no means of escape through the interior of the building or via emergency staircases. The chute 10 of the invention is therefore deployed to ensure safe transit of people from the upper floor to ground level.

As shown in FIG. 3, the frame 38 is attached to a window frame 35 of an upper window 34. The upper end 12 of the chute 10 is anchored to the rectangular support 42 of the frame 38 via the webbing straps 31. The chute 10 unfurls and is suspended in a vertical position alongside the building 33. A person 36 needing to escape from the heat and smoke of the fire, climbs on the frame 38 aided by the hooks 41 and the bar 39. The person 36 then drops through the upper opening 13 and into the funnel portion 11 of the chute 10.

When the person 36 reaches the first band 27, the reduced diameter of the band 27 presents an impediment such that the person 36 cannot pass unimpeded through the inner tube 20. The band 27 restrains the person 36 but under gravity their mass acts to stretch the band 27 within the sleeve 21. The band may expand up to 250% in use, but can tolerate around 400-450% elongation. The expanding bands 27 absorb some of the energy of the person 36 as they descend and therefore reduce their rate of descent. The load of the person 36 and the chute 10 is effectively distributed by the webbing straps 31, 32.

As the bands 27 stretch, the gathered fabric 24 of the inner and outer tube 20, 26 expands to allow the person 36 through the chute 10 (FIG. 4). The excess fabric of the inner and outer tubes 20, 26 provides an air cushion that both slows and alleviates any impact of the descent.

One half of the body of the descending person 36 is hugged by the bands 27 at any one time since the sleeves are 10 cm in width and each sleeve has a 3.5 cm band located therein.

The smaller diameter bands 27 in the braking zone at the lower end 15 of the chute 10 reduces the speed of the person 36 to ensure their safe exit through the lower opening 16. The person 36 can exit onto the soft landing pad 17.

As evident from the description of the embodiment, the chute 10 has greater simplicity and improved functionality compared with existing devices. The lightweight design of the chute 10 and its carry case 46 facilitate transportation of the chute 10 within buildings, offices and flats. As a result the chute 10 is versatile because it is easily moved and stored.

The design of the chute 10 and degree of expansion tolerated by the elastically deformable bands 27 enables use by people with a wide range of sizes, weights and capabilities. The chute 10 permits independent descent by any person at almost the same speed regardless of size and weight. For example, the chute 10 can accommodate people between 15 kg and 180 kg, having a circumference from 45 centimetres to greater than 150 centimetres.

A further advantage of the chute 10 is that the descending user does not need to make any effort to control their speed by bending their legs, using their hands or pushing against an object. The continuity of the bands 27 and the difference in the band 27 diameter along the length of the chute 10 form restrictions that repeatedly hug the body of the descending user. The result is a chute 10 that can safely transport people having a disability, as well as unconscious people and small children or pets in the arms of a descending user. The descent is smooth without a falling impact due to the braking zone.

The chute 10 may be used as an emergency evacuation chute 10 by individual home owners, tenants, office workers and the like. The chute 10 can also be used by the emergency services. For example, the chute may be attached to the end of a long reach ladder of a fire engine or deployed by evacuation crews in helicopters.

According to another embodiment of the invention, the chute 10 is used as recreation equipment and repeatedly enjoyed as a fun slide. A permanent structure with steps for access and a frame to support the chute 10 is erected for this application. Both inner and outer tubes 20, 26 may be manufactured from silicon coated nylon fabric for this particular application to reduce costs.

A further embodiment is shown in FIG. 13. The chute 10 is used to treat a person having non-typical neurological symptoms such as an individual having an autism spectrum disorder (ASD). Use of the chute 10 provides a method of treatment by therapy to enhance wellbeing. According to this application, the person descends within the chute 10 experiencing the hugging and pressing sensation. The chute 10 is fully enclosed and therefore provides a feeling of safety. The calm continuous noise generated by the material of the tubes 20, 26, throughout the sliding experience is soothing. The person exits the chute with an improved feeling of wellbeing due to the physiological stimulation of the chute 10 experience.

According to an alternative embodiment, the chute 10 is used as a conduit for the transportation of building materials and debris. For example, when building work, restructuring and/or refurbishment is carried out on tall buildings, there is often a need to transport building materials and debris safely and efficiently to ground level for subsequent disposal or recycling. The chute 10 may be deployed alongside a tall building or other structure as previously described. Debris and building materials may be sent directly through the chute 10 via the upper opening 13. The lower opening 16 may be positioned above a skip. Alternatively, or additionally, containers may be used and debris can be added to the containers, which are shaped and dimensioned appropriately so that each container travels efficiently along the chute 10. For this application, the chute 10 may have broader dimensions to allow larger items to be transported therein. For example, the first diameter of the bands may be around 50 cm.

Other embodiments can include altered chute 10 and/or tube 20, 26 dimensions, different materials, different arrangement, number and size of bands 27 without departing from the scope of the invention.

According to an alternative embodiment, the width of the sleeves 21 could be increased to reduce overall weight of the chute 10 or increase the speed of descent, which may be desirable for some applications, such as use as a fun slide.

If bands 27 are not added to all the sleeves 21, there will be ‘drops’ within the chute 10. This effect can also be achieved by having wider sleeves 21 (such as 10, 11 or 12 cm sleeve 21 width). This may be desirable for some applications.

The number and location of webbing straps 31, 32 can be altered according to the application and anticipated loading of the chute 10.

As an alternative to using rings 29, the free ends of the bands 27 may be knotted or glued together using a suitable adhesive or heat-bonding.

The materials of the inner and outer tubes 20, 26 should be selected by taking into account the anticipated use and overall weight. The outer tube 26 can comprise more than one material. For example, one half (or another proportion) of the outer tube 26 that is deployed alongside the building 33 in use can comprise a flame resistant material such as Kevlar, while the other half can be made from nylon fabric. This optimises the flame resistant properties of the chute 10, while ensuring overall weight and cost are reduced. Depending on the materials selected, the weight of the chute 10 may vary between around 300 grams per metre and 1200 grams per metre.

The circumference of the inner and outer tubes 20, 26 making up the chute 10 can be increased above 210 cm to accommodate larger sizes.

Although particular embodiments of the invention have been disclosed herein in detail, this is by way of example and for the purposes of illustration only. The aforementioned embodiments are not intended to be limiting with respect to the scope of the statements of invention and appended claims.

It is contemplated by the inventor that various substitutions, alterations, and modifications may be made to the invention without departing from the scope of the invention as defined by the statements of invention and claims. For example, the thickness, width, circumference and spacing of the rubber bands 27 are variables that can be altered according to the application and/or the anticipated user. The band 27 diameter can be lower than 12 cm if desired. The bands 27 described in the embodiments are made from silicon rubber, since these have good durability. However, alternative resilient materials may be used. For example, natural rubber is an alternative option. Natural rubber has the advantage that it is significantly cheaper, although it would need to be stored in carefully monitored conditions to restrict degradation of the material. Natural rubber also has a much shorter shelf life than silicon rubber. Alternative patterns of band 27/sleeve 21 separation can be used according to the specific application. According to another alternative example, the sleeve 21 can be as wide as 20 cm or greater. The chute 10 can still function and other variables can change, such as the thickness and/or width of the bands 27 to compensate for the greater sleeve 21 width. The bands 27 may be selected to have a uniform circumference or diameter along the length of the chute.

The number and distribution of the webbing straps 31, 32 used for reinforcing the chute 10 may be altered according to the desired specification. For example, some webbing straps 31, 32 may be removed where they are not required. Alternatively, the number of straps 31, 31 may be increased to further reinforce the chute 10.

Eyelets may be stitched around the outline of the holes 25 to substantially restrict tearing of the fabric in the region of the holes 25.

Relative terms such as ‘upper’ and ‘lower’, ‘vertical’ and ‘horizontal’ have been used for illustrative purposes and are not intended to be limiting.

1-77. (canceled)

78. A chute for safely transporting a person from a height, the chute comprising,
a substantially flexible cylindrical tube for accommodating a person,
a plurality of circumferential sleeves arranged axially along the tube,
a plurality of bands of elastically deformable material, wherein the bands of elastically deformable material are accommodated in the sleeves; and
wherein the sleeves are spaced such that a plurality of bands are configured to extend circumferentially around a person within the tube in use, to thereby allow safe descent from a height.

79. A chute as claimed in claim 78, wherein the cylindrical tube is adapted to be expandable between a first diameter and a second larger diameter wherein the first diameter of the cylindrical tube corresponds to the diameter of the bands and the second larger diameter of the tube corresponds to the expanded diameter of the elastically deformable bands when accommodating a person, and, optionally, wherein the material of the cylindrical tube is gathered or ruched to allow expansion between the first diameter and the second diameter; and/or
wherein the substantially cylindrical flexible tube comprises an inner tube and an outer tube concentrically arranged outwith the inner tube, and, optionally, wherein the outer tube comprises a material having at least one of the following properties: high strength, low weight, tough, flexible, flame resistant and heat resistant.

80. A chute as claimed in claim 78, wherein each sleeve is formed from a portion of the cylindrical flexible tube; and/or wherein the sleeves are sewn into the cylindrical flexible tube; and/or wherein the sleeves are formed from a portion of an inner cylindrical flexible tube and a portion of an outer cylindrical flexible tube, and, optionally: wherein the inner and outer tubes are concentrically sewn to make circumferential sleeves between each line of sewing; and/or wherein the material of the inner and outer tubes adjacent the circumferential bands is gathered or ruched.

81. A chute as claimed in claim 78, wherein the spacing of adjacent bands is between 1 and 15 centimeters, optionally, between 2 and 12 centimeters, optionally, between 3 and 8 centimeters, optionally, around 10 centimeters.

82. A chute as claimed in claim 78, wherein each band forms a continuous circumferential loop.

83. A chute as claimed in claim 78, wherein each band is formed from a strip of material that is joined at its free ends and wherein the ends are joined without puncturing the material of the band, and, optionally: wherein the free ends of each band are joined at a predetermined circumference by at least one joining member; and/or wherein the free ends of each band are joined by folding the free ends through two rings; and/or wherein longitudinal edges of the outer tube are connected such that the joined ends and bands are inaccessible during normal use.

84. A chute as claimed in claim 78, wherein the diameter of the bands is variable along the length of the chute; and/or wherein the length and resultant diameter of at least a portion of the bands are reduced to retard descent of a user through the chute; and/or wherein a lower end of the chute comprises bands having a reduced diameter to create a braking zone to retard descent of a user; and/or wherein the length and resultant diameter of at least a portion of the bands are increased to increase the speed of descent of a user; and/or wherein an upper portion of the chute comprises bands having an increased diameter to facilitate entry and descent of a user.

85. A chute as claimed in claim 78, wherein the diameter of the circumferential bands is between 10 and 40 centimeters, optionally, between 12 and 35 centimeters, optionally, between 15 and 30 centimeters, optionally, around 11 to 25 centimeters.

86. A chute as claimed in claim 78, wherein the width of the circumferential bands is between 1 and 7 centimeters, optionally, between 2 and 5 centimeters, optionally, between 3 and 4 centimeters, optionally, around 3.5 centimeters.

87. A chute as claimed in claim 78, wherein the thickness of the circumferential bands is between 0.4 and 1.4 mm, optionally, between 0.6 and 1.2 mm, optionally, between 0.8 and 1.0 mm, optionally, around 0.9 mm.

88. A chute as claimed in claim 78, wherein the bands are made from a resilient material such that they elastically deform on contact with a force; and/or wherein the bands are made from a resilient material such that they absorb energy by hysteresis.

89. A chute as claimed in claim 78, wherein the weight of the chute is below 1200 grams per meter, optionally, below 750 grams per meter, optionally, below 500 grams per meter.

90. A chute as claimed in claim 78, wherein the chute further comprises a reinforcing means for increasing the strength of the chute; and/or wherein the chute further comprises a load distributer to distribute the load carried by the chute along the length of the chute.

91. A chute as claimed in claim 78, wherein the chute comprises at least one longitudinal webbing strap sewn along the length of the chute to add strength and distribute the load, and, optionally, wherein the chute comprises at least one webbing strap sewn circumferentially around the chute and joined to the at least one longitudinal webbing strap; and/or
wherein the chute comprises four longitudinal webbing straps sewn to the exterior of the cylindrical tube to add strength to the chute and distribute the load, and, optionally, wherein the chute is attachable to a frame by means of a looped longitudinal webbing straps acting as an anchor means.

92. A chute as claimed in claim 78, wherein the chute is collapsible to fit within a carry case; and/or wherein the chute comprises a carry case for enclosing the chute; and/or wherein the chute further comprises a frame for supporting the chute at an upper end alongside another structure, and, optionally, wherein at least one of the chute and the frame is provided with anchor means for anchoring the chute to the frame.

93. A chute as claimed in claim 78 wherein: the chute is an emergency evacuation chute; and/or the chute is recreation equipment; and/or the chute is a therapeutic device for stimulating a physical sensation to enhance wellbeing.

94. A method of enabling a person to descend safely from a height, the method comprising the steps of:
providing a substantially flexible cylindrical tube comprising a plurality of bands of elastically deformable material accommodated within a plurality of circumferential sleeves axially arranged along the tube and spacing the bands such that several bands extend circumferentially around a person within the chute in use,
allowing a person to enter an upper open end of the tube,
allowing descent of the person by gravity, and
controlling the speed of descent by absorbing a portion of the energy of the descent by elastically deforming the plurality of bands.

95. A kit of parts for an evacuation chute, the kit of parts comprising the chute as claimed in claim 78, a frame adapted to anchor the chute, wherein the frame is securable to a structure to allow vertical or near vertical deployment of the chute.

96. A method of manufacture of a chute, the method including the steps of:
forming a substantially flexible cylindrical tube,
creating a plurality circumferential sleeves axially arranged along the tube,
inserting bands of an elastic material into the sleeves, and
securing free ends of each band around at least one joining member to form a loop with a predetermined circumference, and, optionally, including securing the free ends of each band using two rings and threading the free ends around the rings.

97. A method of treatment by therapy comprising:
providing a substantially flexible cylindrical tube and a plurality of bands of elastically deformable material accommodated within a plurality of axially arranged circumferential sleeves,
enabling a person with non-typical neurological symptoms to descend within the tube by virtue of gravity,
controlling the speed of descent by absorbing a portion of the energy of the descent by elastically deforming the plurality of bands, and
thereby increasing the wellbeing of the person descending.
